(19) United States
(12) Patent Application Publication
(10) Pub. No.: US 2011/0157863 A1
(43) Pub. Date: Jun. 30, 2011

(54) ENHANCED VISIBILITY CLOTHING AND SAFETY DEVICES, AND METHODS OF ILLUMINATING CLOTHING

(75) Inventor: Scott F. GRIMSHAW, Greenville, SC (US)

(73) Assignee: Tangidyne LLC, Greenville, SC (US)

(21) Appl. No.: 12/648,894

(22) Filed: Dec. 29, 2009

(51) Int. Cl. F21K 2/06; G21G 4/00

(52) U.S. Cl. 362/34; 250/493.1

(57) ABSTRACT

A safety device comprising an article of clothing, first and second chambers in which first and second chemiluminescent compositions (which, if mixed, would produce electromagnetic radiation) are positioned, respectively. Also, a safety device comprising an article of clothing, tubing affixed to the clothing, the tubing defining a first chamber, first and second chemiluminescent compositions and a pump which is activatable to move at least the first chemiluminescent composition within the first chamber. Also, a method of illuminating an article of clothing, comprising mixing first and second chemiluminescent compositions to form a chemiluminescent mixture, and pumping the chemiluminescent mixture within at least a first chamber. Also, a method of illuminating an article of clothing, comprising mixing first and second chemiluminescent compositions in a first chamber, the first chamber being affixed to an article of clothing.

### FIELD OF THE INVENTIVE SUBJECT MATTER

The present inventive subject matter relates to articles of clothing and safety devices that enhance the visibility of a wearer, and to articles of clothing and safety devices that are adaptable to varying applications. The present inventive subject matter also relates to methods of illuminating articles of clothing.

### BACKGROUND

For safety reasons, it is often desirable to be able to wear clothing which is easily seen in low or no light conditions. For example, in many instances, it is desirable for personnel on a ship at sea to be visible, especially in the event that they fall overboard. Similarly, people exercising outdoors in the early morning or at dusk often wear reflective clothing, or attach a clip-on flashing light to their clothes, so that they will be more visible to drivers. Another situation such clothing may be desirable is where a person is in a smoky environment, e.g., a firefighter. Clothing that includes one or more lights may also be desired for novelty reasons, such as at dance parties, or as part of a costume.

One way that clothing has been made more visible is by adding retro-reflective materials to the clothing. Retro-reflective materials work on a principle of reflection. For example, light from an external source (e.g., an automobile headlight) hits the material and is reflected (or re-emitted) by the material (e.g., bounced back so as to be visible to the driver of the automobile). With such arrangements, it is sometimes the case that the wearer of the clothing does not become visible unless and until the light is incident upon the clothing with a high enough intensity that the reflected or re-emitted light is visible. Accordingly, there exists the inherent danger that such clothing will not provide the necessary degree of visibility in some situation, e.g., a jogger might not be visible to a driver of an automobile until the jogger is at close range, possibly not leaving enough time to react and avoid hitting the jogger.

In many other cases, apparel or devices require a separate and/or independent light source for illumination, require bulky wires and battery packs, and/or require that light be provided by an external source. All of this can be awkward for the wearer, and may provide risks if the batteries wear out, or lights are damaged.

As an example where light emitting diodes (LEDs) are used, each LED may be mounted and connected to an electrical circuit housed within, or mounted on, the garment. Typically, a battery pack is mounted within the article or garment, and connected by a flexible electrical circuit board attached to the garment in a predetermined design or shape. A number of LEDs may be electrically connected to the circuit board and, typically, protrude through apertures formed in the outer surface of the garment.

In addition to having to incorporate bulky wiring and electric circuitry, a problem with garments wherein lights or LEDs protrude through an aperture is that the LEDs can be damaged or broken as a result of being exposed. In addition, some garments and other articles of clothing may be of such a nature that visibility of a circuit board and/or LEDs protruding through apertures within the garment might be deemed to be undesirable. Garments that include one or more lights that require electricity may fail (or create safety hazards) in situations where the wearer gets wet or is in water, even if the garment is battery-powered.

### BRIEF SUMMARY OF THE INVENTIVE SUBJECT MATTER

The present inventive subject matter provides articles of clothing and safety devices that provide visibility, e.g., in low or no-light situations.

In some aspects, the present inventive subject matter provides articles of clothing and safety devices that do not require any electricity (battery power or otherwise), and that do not require incident light, to provide electromagnetic radiation, e.g., visible illumination.

In some aspects, the present inventive subject matter provides articles of clothing and safety devices, that may include or not include any of the features described above, in which the time (or times) when the electromagnetic radiation is emitted can be selected, e.g., by the wearer of the article of clothing.

In accordance with one aspect of the present inventive subject matter, there is provided an article of clothing comprising:

a first chamber in which at least a first chemiluminescent composition is positioned; and

a second chamber in which at least a second chemiluminescent composition positioned,

wherein if the first chemiluminescent composition and the second chemiluminescent composition are mixed to form a mixture, the mixture would produce electromagnetic radiation.

In accordance with another aspect of the present inventive subject matter, there is provided a safety device comprising:

an article of clothing;

tubing affixed to the article of clothing, the tubing defining at least a first chamber;

at least a first chemiluminescent composition and a second chemiluminescent composition; and

at least one pump which is activatable to move at least the first chemiluminescent composition within the first chamber,

wherein if the first chemiluminescent composition and the second chemiluminescent composition are mixed to form a mixture, the mixture would produce electromagnetic radiation.

The term “affixed”, e.g., in the expression “tubing affixed to the article of clothing” means that the first structure (e.g., the tubing) is adhered, linked or tethered to the second structure (e.g., the article of clothing) so that it at least travels together with the second structure, and can be held fairly closely in place relative to the second structure (e.g., the spacing between their respective centers of gravity can change by not more than one centimeter when a force of 1 Kgf is applied to the first structure and not the second structure), or can move to some larger extent relative to the second structure (e.g., the spacing between their respective centers of gravity can change by up to one meter when a force of 1 Kgf is applied to the first structure and not the second structure).

The word “activatable”, as used in the expression “pump which is activatable to move at least the first chemiluminescent composition within the first chamber”, means that the structure (e.g., the pump) that is “activatable” can be activated to cause the specified activity to occur (e.g., move at least the first chemiluminescent composition within the first chamber), for example, squeezing a flexible structure that defines a chamber of a squeeze-pump causes the pump to force a chemiluminescent composition to move, or, likewise, pumping a piston can similarly cause movement of a chemiluminescent composition, etc.

In accordance with another aspect of the present inventive subject matter, there is provided a method of illuminating an article of clothing comprising:

mixing at least a first chemiluminescent composition and a second chemiluminescent composition to form a chemiluminescent mixture; and

pumping the chemiluminescent mixture within at least a first chamber.

In accordance with another aspect of the present inventive subject matter, there is provided a method of illuminating an article of clothing comprising:

mixing at least a first chemiluminescent composition and a second chemiluminescent composition in at least a first chamber, the first chamber being affixed to an article of clothing.

The inventive subject matter may be more fully understood with reference to the accompanying drawings and the following detailed description of the inventive subject matter.

### BRIEF DESCRIPTION OF THE DRAWING FIGURES

FIGS. 1-4 illustrate an embodiment of a safety device 10 in accordance with the present inventive subject matter.

FIGS. 5 and 6 illustrate another embodiment of a safety device 20 in accordance with the present inventive subject matter.

FIGS. 7 and 8 illustrate another embodiment of a safety device 30 in accordance with the present inventive subject matter.

### DETAILED DESCRIPTION OF THE INVENTIVE SUBJECT MATTER

Safety devices according to the present inventive subject matter comprise at least one article of clothing.

The at least one article of clothing can generally be any suitable article of clothing. Representative examples of suitable articles of clothing include jackets, body suits, overalls, pants, sweatshirts, shirts, sweat suits, socks, hats, etc. The article of clothing can comprise any desired number of components, e.g., one piece, two pieces, etc. (for instance, the article of clothing could be a jacket with a hood, a sweat suit comprising sweat pants and a sweatshirt, etc.).

The at least one article of clothing may be made out any suitable material or combination of materials. Representative examples of suitable materials include cotton, polyester, rubber, leather and neoprene. The respective articles of clothing in safety devices that have two or more articles of clothing can be made of the same material or combination of materials, and/or can be of different materials or combinations of materials. In some embodiments, the article of clothing (or one or more of plural articles of clothing) may be made of insulating material so that it can provide warmth as well as increased safety.

In some embodiments, to provide or to improve stealth characteristics of a safety device, such as for military or hunting applications, the article of clothing may be made of a material (or combination of materials) that reduce or minimize sound created when the article of clothing rubs against itself, other clothing or other objects typically in an environment, e.g., cotton.

The at least one article of clothing may be any color, color pattern or combinations thereof, e.g., it (or one or more of plural articles) may be white or a bright color to increase its visibility, or may be a color (or color combination, e.g, camouflage) designed to blend in with specific surrounding environments.

The at least one article of clothing may comprise reflective material. A reflective material, if employed, may be located on any portion of the reflective material, such as a reflective strip attached to a sleeve. In some embodiments that include a reflective material, the reflective material, e.g., reflective strips, can be detachable, for example, by using velcro, by providing hook or loop strips with corresponding hook or loop strips attached to the reflective material, or by providing snaps, buttons, zippers, tape, or any other way to releasably attach reflective material.

Safety devices according to the present inventive subject matter comprise at least a first chamber. The chamber can be defined by chamber walls that can be made of any suitable material. In embodiments that comprise two or more chambers, the second and any additional chambers can likewise be defined by chamber walls made of any suitable material, and walls of respective chambers can be made of the same material (or materials) or of different materials (or materials).

In some embodiments, at least one chamber can be defined by tubing. In some of such embodiments, the tubing can be flexible, and/or can be at least partially transparent or translucent. The word “tubing”, as used herein, can refer to uniform or non-uniform structures, i.e., the tubing can be of uniform cross-section or non-uniform cross-section (i.e., its cross-section can be circular, elliptical, square, abstract, etc., or different regions can have different cross-sectional shapes), and the tubing can be of substantially constant size (e.g., distance around a cross-section) or different regions can be of different sizes.

In some embodiments, one or more structures that at least partially define one or more chambers can be shaped so as to conform to the shape of one or more other portions of the safety device, e.g., one of the chambers can be defined by flexible tubing that conforms to the shape of an article of clothing (and to the shape of the wearer).

Any of the at least one chamber can be positioned within one or more of the at least one article of clothing, and/or can be defined by walls that are attached to one or more of the at least one article of clothing, and/or can be defined completely or partially by portions of the material of the article of clothing itself. In embodiments in which the chamber (or at least one of the chambers) is attached to an article (or articles) of clothing, the chamber(s) can be attached to the article (or articles) of clothing in any way, e.g., using velcro, by providing a pocket (that may be closed partially or completely around a structure that defines the chamber), by providing hook or loop strips with corresponding hook or loop strips attached to a structure that defines the chamber, or by providing snaps, clips, stitching, buttons, zippers, tape, magnets, adhesive, or any other way to releasably attach a structure that defines the chamber.

In some embodiments, the at least one article of clothing can comprise one or more openings through which a structure that defines one or more chambers (or through which two or more structures that define one or more chambers) can be threaded. In such embodiments, the one or more articles of clothing can comprise one or more at least partially transparent or translucent sections through which electromagnetic radiation can shine.

Safety devices according to the present inventive subject matter comprise at least a first chemiluminescent composition and a second chemiluminescent composition. The respective chemiluminescent compositions are selected such that when they are combined, electromagnetic radiation (e.g., visible light, near ultraviolet light, ultraviolet light, infrared light) is generated.

Persons of skill in the art are familiar with a variety of combinations of chemiluminescent compositions which, when combined, generate electromagnetic radiation, and any of such combinations can be employed. For example, some combinations of chemiluminescent compositions that generate electromagnetic radiation when combined comprise (1) an oxalate and (2) an activator. In some embodiments, one of the compositions comprises an oxalic acid ester and a solvent, and the other of the compositions comprises a peroxide component comprising hydrogen peroxide and a solvent or mixture of solvents. In some embodiments, one or more catalyst(s) may be employed, if desired. Persons of skill in the art are familiar with a variety of catalysts that can be used with various combinations of chemiluminescent compositions, and any of such catalysts can be employed in the safety devices according to the present inventive subject matter.

Optionally, one or more of the compositions can comprise one or more luminescent materials (e.g., one or more phosphors) which can absorb electromagnetic radiation (e.g., light) generated by the combined chemiluminescent compositions and re-emit electromagnetic radiation of one or more wavelength that can differ from the wavelength (or wavelengths) of the electromagnetic radiation generated by the combined chemiluminescent compositions.

In some embodiments of safety devices according to the present invention, a first chemiluminescent composition is provided in a first chamber, a second chemiluminescent composition is provided in a second chamber, and the first chemiluminescent composition can be caused to mix with the second chemiluminescent composition in order to generate electromagnetic radiation. In some of such embodiments, one of the chemiluminescent compositions can be pumped into the other chemiluminescent composition (or one or more of the other chemiluminescent compositions). In some embodiments, which may include or not include a pump, a valve can be opened to allow one of the chemiluminescent compositions to flow into the other chemiluminescent compositions (or one or more of the other chemiluminescent compositions), e.g., by gravity or by moving one or more components of the safety device, or by pumping one or both of the chemiluminescent compositions. In some embodiments, which may include or not include any of the features described above, one or more chambers (an “inside” chamber or two or more “inside” chambers) can be positioned within one or more other chambers (an “outside” chamber or two or more “outside” chambers), e.g., the second chamber can be positioned inside the first chamber, and the “inside” chamber can be broken (e.g., by bending it, compressing it, pressurizing it, etc.) in order to release the chemiluminescent composition from the “inside” chamber into the “outside” chamber, so that the two (or more) compositions can mix (for example, in some embodiments, the “inside” chamber can be an ampoule, e.g., a frangible glass ampoule). In some embodiments, which may include or not include any of the features described above, the contents of at least two chambers can be mixed in another vessel (i.e., something other than those at least two chambers), e.g., a third chamber or tubing, e.g., flexible tubing (which can be at least partially transparent or translucent). In some embodiments, which may include or not include any of the features described above, at least two chemiluminescent compositions can be prevented from mixing by at least one seal (alone or in addition to other things that prevent mixing) which can be pierced or otherwise rendered incapable of preventing mixing when it is desired for the safety device to emit visible light or other electromagnetic radiation.

Regardless of where the chambers are positioned, safety devices can be constructed so that the mixtures of chemiluminescent compositions can be caused to flow to desired regions of the safety devices, e.g., to particular regions on the article(s) of clothing that are part of the safety devices (e.g., chemiluminescent compositions can mix in flexible tubing that extends around a perimeter of one or both sides of a jacket.

Some embodiments of safety devices according to the present inventive subject matter comprise a pump. Persons of skill in the art are familiar with a wide variety of structures that can pump fluid, and any of such structures can be employed in the safety devices according to the present inventive subject matter. For example, some embodiments can comprise a hand-held pump (e.g., a flex or accordion-type plastic pump, that a user or other person can squeeze to cause one or more chemiluminescent composition to flow and/or for a structure or structures in which one or more chemiluminescent compositions are contained to be broken so that two or more chemiluminescent compositions mix).

The pump (or pumps) can cause the chemiluminescent composition(s) to flow by any suitable way of exerting force, e.g., by drawing a vacuum that pulls the chemiluminescent composition(s), by creating pressure that exerts force on the chemiluminescent composition(s) and causes the chemiluminescent composition(s) to flow, by directly moving the chemiluminescent composition(s) (e.g., a rotating impeller that pushes the fluid), etc.

In some embodiments, one or more of the chambers can be refilled. In some of such embodiments, one chamber (or each of more than one chamber) may comprise a removable screw caps or other removable and re-sealable structure.

In some embodiments, the safety device can comprise one or more storage pockets or pouches for receiving a pump and/or additional containers in which a chemiluminescent composition is positioned. Such a pocket or pouch can alternatively or additionally be used to carry a survival pack, a first aid kits, and/or one or more item such as spare batteries or flashlights.

In some embodiments that comprise a pump, disconnects can be provided to allow the pump to be disconnected from one or more of the chamber.

In some embodiments, one or more structures that define one or more chambers can be removed and/or replaced, e.g., when the contents within the chamber(s) has been depleted (or at least partially spent). In addition, by changing out one or more chambers, different chemiluminescent compositions can be used (and, if desired, different intensities, types of electromagnetic radiation, wavelengths of a particular type of electromagnetic radiation, e.g., color or color combinations of emissions, can be generated upon mixing the contents of two or more chambers.

In some embodiments, two or more valves can be provided to control rates of release of the chemiluminescent compositions independently.

In some embodiments, the safety device can be manipulated to alter the shape of the regions from which visible light (or other electromagnetic radiation) is emitted, e.g., the user can alter the location and/or shape of one or more chamber in which chemiluminescent compositions can be mixed.

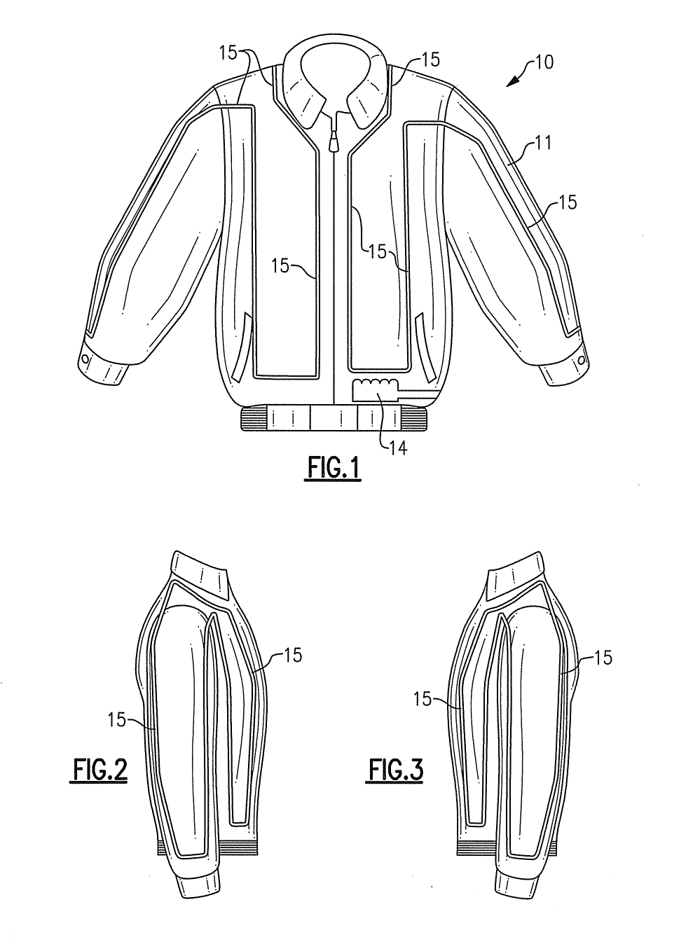

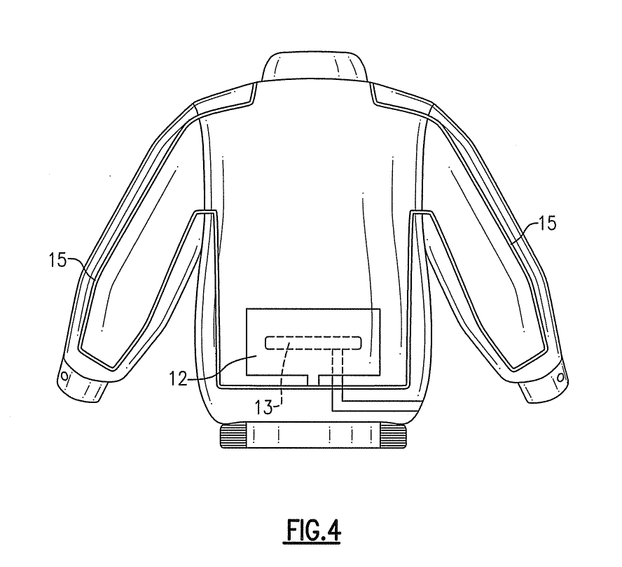

FIGS. 1-4 schematically illustrate an embodiment of a safety device 10 in accordance with the present inventive subject matter.

The safety device 10 comprises an article of clothing 11 (in this embodiment, a jacket), a first chamber 12, a second chamber 13 and a pump 14. A first chemiluminescent composition is positioned in the first chamber 12, and a second chemiluminescent composition is positioned in the second chamber 13. The pump 14 comprises a squeezable chamber and pump tubing that communicate with a pump chamber inside the second chamber 13, the pump chamber being sealed from the second chemiluminescent composition (alternatively, the interior of the squeezable chamber, the interior of the pump tubing and the interior of the second chamber 13 can all communicate with each other and can all be filled with the second chemiluminescent composition). When it is desired to illuminate the jacket, the pump 14 can be squeezed, which increases pressure within the second chamber 13 and causes the second chamber 13 to break, releasing the second chemiluminescent composition into the first chamber 12 where it mixes with the first chemiluminescent composition to generate visible light. The pressure created by squeezing the pump 14 also causes the mixed first and second chemiluminescent compositions to spread throughout the tubing 15 extending around the perimeter of the jacket 11 on both the front and back sides.

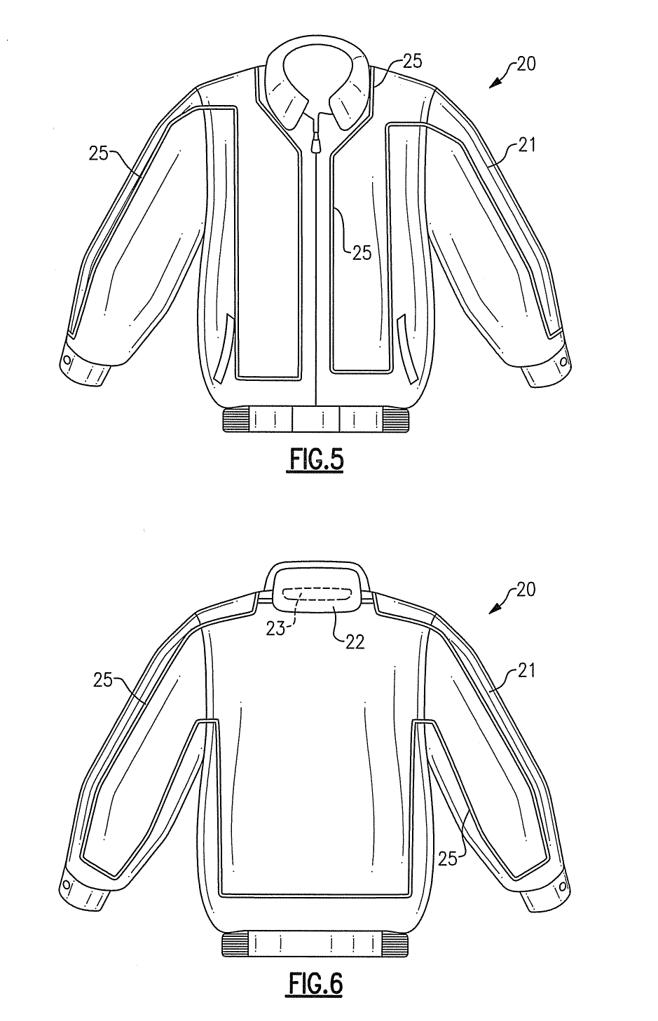

FIGS. 5 and 6 schematically illustrate another embodiment of a safety device 20 in accordance with the present inventive subject matter.

The safety device 20 comprises an article of clothing 21 (in this embodiment, a jacket), a first chamber 22 and a second chamber 23. A first chemiluminescent composition is positioned in the first chamber 22, and a second chemiluminescent composition is positioned in the second chamber 23. When it is desired to illuminate the jacket, the first chamber 22 can be bent, which causes the second chamber 23 to break, releasing the second chemiluminescent composition into the first chamber 22 where it mixes with the first chemiluminescent composition to generate visible light. Gravity causes the mixed first and second chemiluminescent compositions to spread throughout the tubing 25 extending around the perimeter of the jacket 21 on both the front and back sides.

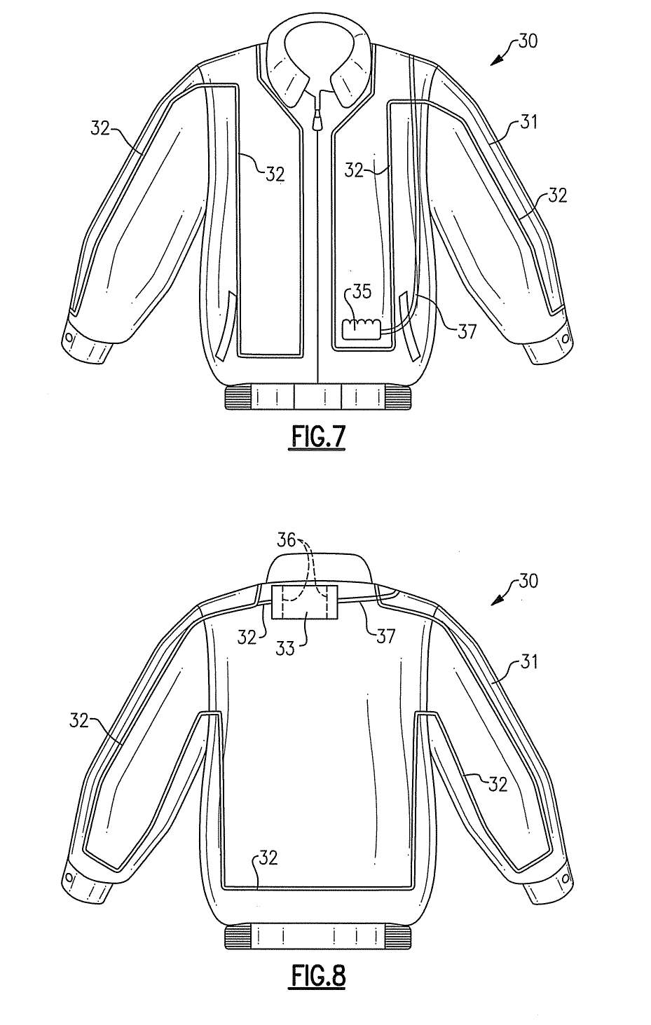

FIGS. 7 and 8 schematically illustrate another embodiment of a safety device 30 in accordance with the present inventive subject matter.

The safety device 30 comprises an article of clothing 31 (in this embodiment, a jacket), a first chamber 32 (in the form of tubing) and a second chamber 33. A squeezable chamber 35 communicates with the inside of the second chamber 33 through tubing 37. A first chemiluminescent composition is positioned in the first chamber 32, and a second chemiluminescent composition fills the second chamber 33, the squeezable chamber 35 and the tubing 37. Seals 36 separate the second chamber 33 from the first chamber 32. When it is desired to illuminate the jacket, the squeezable chamber 35 can be squeezed, which increases pressure within the second chamber 33 and causes the seals 36 to break, releasing the second chemiluminescent composition into the first chamber 32 where it mixes with the first chemiluminescent composition to generate visible light. Gravity causes the mixed first and second chemiluminescent compositions to spread throughout the tubing 35 extending around the perimeter of the jacket 31 on both the front and back sides.

Any two or more structural parts of the safety devices described herein can be integrated. Any structural part of the safety devices described herein can be provided in two or more parts (which may be held together in any known way, e.g., with adhesive, screws, bolts, rivets, staples, etc.).

1. A safety device comprising:
at least one article of clothing;
a first chamber;
a second chamber;
at least a first chemiluminescent composition positioned in the first chamber; and
at least a second chemiluminescent composition positioned in the second chamber,
wherein if the first chemiluminescent composition and the second chemiluminescent composition are mixed to form a mixture, the mixture would produce electromagnetic radiation.

2. A safety device as recited in claim 1, wherein if the first and second chemiluminescent compositions are mixed, they would produce visible light.

3. A safety device as recited in claim 1, wherein if the first and second chemiluminescent compositions are mixed, they would produce infrared light.

4. A safety device as recited in claim 1, wherein the first chemiluminescent composition comprises at least one chemiluminescent reactant material and at least one catalyst material.

5. A safety device as recited in claim 1, wherein the second chemiluminescent composition comprises hydrogen peroxide.

6. A safety device as recited in claim 1, wherein the first chamber is positioned within a flexible element.

7. A safety device as recited in claim 1, wherein the first chamber is defined by tubing.

8. A safety device as recited in claim 1, wherein the second chamber is defined by a frangible container.

9. A safety device as recited in claim 8, wherein the second chamber is positioned within the first chamber.

10. A safety device as recited in claim 1, wherein the safety device further comprises at least one pump.

11. A safety device as recited in claim 1, wherein the safety device further comprises at least one valve.

12. A safety device as recited in claim 1, wherein at least one of the first and second chambers is capable of being emptied and refilled.

13. A safety device as recited in claim 1, wherein at least one of the first and second chambers is removably affixed to the safety device.

14. A safety device comprising:
at least a first article of clothing;
tubing affixed to the first article of clothing, the tubing defining at least a first chamber;
at least a first chemiluminescent composition and a second chemiluminescent composition; and
at least one pump which is activatable to move at least the first chemiluminescent composition within the first chamber,
wherein if the first chemiluminescent composition and the second chemiluminescent composition are mixed to form a mixture, the mixture would produce electromagnetic radiation.

15. A safety device as recited in claim 14, wherein if the first and second chemiluminescent compositions are mixed, they would produce visible light.

16. A safety device as recited in claim 14, wherein if the first and second chemiluminescent compositions are mixed, they would produce infrared light.

17. A safety device as recited in claim 14, wherein the first chemiluminescent composition comprises at least one chemiluminescent reactant material and at least one catalyst material.

18. A safety device as recited in claim 14, wherein the second chemiluminescent composition comprises hydrogen peroxide.

19. A safety device as recited in claim 14, wherein the first chamber is positioned within a flexible element.

20. A safety device as recited in claim 14, wherein the first chamber is defined by tubing.

21. A safety device as recited in claim 14, wherein the safety device further comprises a second chamber, and the pump is activatable to mix and distribute the first and second chemiluminescent compositions throughout the first and second chambers.

22. A safety device as recited in claim 14, wherein the pump is activatable to move at least one of the first and second chemiluminescent compositions within the first chamber.

23. A safety device as recited in claim 14, wherein the safety device further comprises at least one valve.

24. A safety device as recited in claim 14, wherein the pump is capable of controlling a rate of chemiluminescent composition distribution.

25. A safety device as recited in claim 14, wherein the pump is capable of controlling the distribution rate of each chemiluminescent composition separately.

26. A safety device as recited in claim 14, wherein the pump comprises a chemiluminescent composition storage chamber.

27. A safety device as recited in claim 14, wherein the safety device further comprises a second chamber, and at least one of the first and second chambers is in removable communication with the pump.

28. A safety device as recited in claim 14, wherein the safety device further comprises a second chamber, and the pump is activatable to break the second chamber.

29. A safety device as recited in claim 14, wherein the safety device further comprises a second chamber, and the pump is activatable to release the second chemiluminescent composition from the second chamber.

30. A safety device as recited in claim 14, wherein the pump is removably affixed to the article of clothing.

31. A method of illuminating an article of clothing, the method comprising:
mixing at least a first chemiluminescent composition and a second chemiluminescent composition to form a chemiluminescent mixture; and
pumping the chemiluminescent mixture within at least a first chamber.

32. A method of illuminating an article of clothing, the method comprising:
mixing at least a first chemiluminescent composition and a second chemiluminescent composition in at least a first chamber, the first chamber being affixed to an article of clothing.
